(19) United States
(12) Patent Application Publication
(10) Pub. No.: US 2024/0169312 A1
(43) Pub. Date: May 23, 2024

(54) FULFILLMENT-BASED CROSS-BORDER E-COMMERCE SERVICE PROVIDING DEVICE, OPERATION METHOD THEREOF, AND COMPUTER PROGRAM FOR EXECUTING PROCESS THEREOF

(71) Applicant: COLOSSEUM CORPORATION, INC., Seoul (KR)

(72) Inventor: Jinsu PARK, Seoul (KR)

(21) Appl. No.: 18/551,845

(22) PCT Filed: Mar. 28, 2022
(86) PCT No.: PCT/KR2022/004314

§ 371 Date: Sep. 21, 2023

(30) Foreign Application Priority Data
Mar. 26, 2021 (KR) 10-2021-0039386
Mar. 26, 2021 (KR) 10-2021-0039389

(51) Int. Cl. G06Q 10/087; G06Q 30/0601

(52) U.S. Cl. CPC G06Q 10/087; G06Q 30/0635

(57) ABSTRACT

A method of operating a fulfillment-based cross-border e-commerce service providing device according to an embodiment of the present disclosure may include a registration step of registering product information transmitted from a seller terminal or a warehouse center terminal; a management step of managing logistics data configuration information corresponding to one or more products based on the product information; a receiving step of receiving purchase information received from a purchaser terminal and transmitted via an e-commerce platform or the seller terminal; an analysis step of performing analysis for cross-border logistics processing based on order data corresponding to a preset fulfillment dataset on the basis of the purchase information and the logistics data configuration information, and acquiring fulfillment order information as a result of the analysis; and a processing step of processing a logistics process corresponding to one or more purchased products based on the fulfillment order information.

### TECHNICAL FIELD

The present disclosure relates to a fulfillment-based cross-border e-commerce service providing device and an operation method thereof. More specifically, the present disclosure relates to a fulfillment-based cross-border e-commerce service providing device of, when an overseas consumer purchases products through a domestic e-commerce platform, providing a fulfillment-based logistics service that performs all-round logistics services such as warehousing and storage of products, release and shipment of a purchaser's order, return, settlement, and inventory management, and an operation method thereof.

### BACKGROUND ART

Electronic commerce, expressed as e-commerce, means a transaction in which products and services are bought and sold in real time using the Internet through a virtual market opened on-line. The electronic commerce is rapidly spreading through an increase in the Internet users and the utilization of smartphones based on the development of ICT technologies.

In recent years, the utilization of e-commerce, which is a non-face-to-face type of product purchase method that is not limited by time and space, is growing exponentially as social environment variables that lead to non-face-to-face lives have been brought about.

Furthermore, through e-commerce, time constraints on sales may be removed for sellers, and efficiency may be improved for purchasers to reduce the troubles of visiting offline stores and searching for product information. The efficiency of fulfillment services that maintain the quality and value of products, reduce the work and costs of sellers and warehouse owners, and execute a professional logistics service on behalf thereof may be considered as an important factor in a packaging method of purchased products shipped to purchasers through e-commerce.

In addition, cross-border e-commerce, which is a cross-border e-commerce transaction in which transaction entities belonging to different countries transact products online, is being activated. Cross-border e-commerce can be made in the form of overseas direct purchase by domestic consumers (direct purchase) and direct purchase of domestic products by overseas consumers (reverse direct purchase). In recent years, as the direct purchase of domestic products by overseas consumers (reverse direct purchase) has increased, the importance of fulfillment-based omnidirectional and efficient logistics services for this purpose has emerged.

In order to provide logistics services provided when overseas consumers directly purchase domestic products through such e-commerce, a method of providing customized shipment services for overseas consumers is disclosed as described in Korean Patent Registration No. 10-1660822. The registered patent relates to a method of providing a customized shipment service for overseas customers, and there is disclosed a method of providing a customized shipment service for overseas customers visiting the country, which is executed by a server operating a shopping mall exclusively for overseas customers, the method including a first step of, when ordering a product from an overseas customer, checking whether domestic shipment is requested for the ordered product, a second step of, when the domestic shipment request is confirmed, providing information on one or more domestic delivery destinations where the product can be delivered to the overseas customer's terminal, a third step of, when the overseas customer visits the country, recommending and selecting a domestic delivery destination close to a place to stay through the overseas customer's terminal, a fourth step of checking the overseas customer's visit schedule information for the domestic delivery destination selected by the overseas customer, and a fifth step of comparing a time period taken for the product ordered by the overseas customer to be delivered to the selected domestic delivery destination and the overseas customer's visit schedule to determine whether the delivery can be made within the visit schedule, wherein when it is difficult to deliver the product to the domestic delivery destination within the overseas customer's visit schedule, the fifth step checks a domestic delivery location where the delivery can be made within the overseas customer's schedule to provide it to the overseas customer's mobile phone.

However, through the related art, there is a restriction in that overseas customers must purchase a product they want to purchase from a shopping mall exclusively for overseas customers, and in the case of purchasing a product from the shopping mall exclusively for overseas customers, there is a limitation in that information on a place where a domestic delivery destination other than an overseas customer's actual residence can be registered or a place where a domestic visit is scheduled to pick up the product. The related art is limited to a delivery service that allows overseas customers to receive purchased products when visiting the country. As such, the related art has limitations in applying logistics services that must be provided cross-border when transaction entities belonging to different countries transact products online.

### DISCLOSURE OF INVENTION

### Technical Problem

The present disclosure is contrived to solve the above problems, an aspect of the present disclosure is to provide a fulfillment-based cross-border e-commerce service providing device that analyzes order data for overseas shipment based on fulfillment and processes a logistics process when an overseas customer purchases a product using a domestic e-commerce platform in case where transaction entities belonging to different countries transact products online, and an operation method thereof.

### Technical Solution

In order to solve the foregoing problems, a method according to an embodiment of the present disclosure may include a registration step of registering product information transmitted from a seller terminal or a warehouse center terminal; a management step of managing logistics data configuration information corresponding to one or more products based on the product information; a receiving step of receiving purchase information received from a purchaser terminal and transmitted via an e-commerce platform or the seller terminal; an analysis step of performing analysis for cross-border logistics processing based on order data corresponding to a preset fulfillment dataset on the basis of the purchase information and the logistics data configuration information, and acquiring fulfillment order information as a result of the analysis; and a processing step of processing a logistics process corresponding to one or more purchased products based on the fulfillment order information.

In addition, in order to solve the foregoing problems, a device according to an embodiment of the present disclosure may include a registration unit that registers product information transmitted from a seller terminal or a warehouse center terminal; a management unit that manages logistics data configuration information corresponding to one or more products based on the product information; a receiving unit that receives purchase information received from a purchaser terminal and transmitted via an e-commerce platform or the seller terminal; an order information analysis unit that performs analysis for cross-border logistics processing based on order data corresponding to a preset fulfillment dataset on the basis of the purchase information and the logistics data configuration information, and acquires fulfillment order information as a result of the analysis; and a logistics processing unit that processes a logistics process corresponding to one or more purchased products based on the fulfillment order information.

Meanwhile, in order to solve the foregoing problems, the method according to an embodiment of the present disclosure may be implemented as a computer program stored in a computer-readable recording medium for executing the method on a computer.

### Advantageous Effects

According to an embodiment of the present disclosure, based on product information registered by a seller in a domestic e-commerce platform, product order information purchased by an overseas resident may be displayed together in a designated language and converted into a unified order form so as to be applied to a domestic fulfillment service, thereby preventing confusion in logistics information processing as well as preventing incorrect delivery.

Additionally, in providing an overseas logistics service, multi-packaging and multi-shipping services may be provided through repackaging according to an identification value of shipping information, rather than shipping one or more purchased products for each single item, thereby providing cost reduction and efficient transportation processing. Besides, a multi-packaging method of products may be optimized while replacing inefficient packaging work based on the experience and subjective judgment of a person in charge of packaging through modeling a fitting arrangement of 3D solid shape objects using purchased products or a primary packaging form during multi-packaging and a load method that minimizes a hollow formed therein, thereby minimizing the waste of packaging material resources and costs due to excessive packaging.

Moreover, a procedure for shipping while at the same time warehousing products may be carried out by utilizing pre-shipment instruction information of purchased products according to an overseas customer's purchase information, thereby reducing logistics processing time.

### BRIEF DESCRIPTION OF THE DRAWINGS

FIG. 1 is a conceptual diagram schematically showing an overall system according to an embodiment of the present disclosure.

FIG. 2 is a block diagram showing in more detail a fulfillment-based cross-border e-commerce service providing device according to an embodiment of the present disclosure.

FIG. 3 is a block diagram showing in more detail a partial configuration of the fulfillment-based cross-border e-commerce service providing device according to the embodiment of the present disclosure.

FIG. 4 is a flowchart for explaining in more detail an operation of the fulfillment-based cross-border e-commerce service providing device according to the embodiment of the present disclosure.

FIG. 5 is an exemplary diagram for explaining shipment packaging information provided through the fulfillment-based cross-border e-commerce service providing device according to the embodiment of the present disclosure.

### BEST MODE FOR CARRYING OUT THE INVENTION

The following description illustrates the principles of the present disclosure. It will thus be appreciated that those skilled in the art will be able to devise various devices that, although not explicitly described or shown herein, embody the principles of the invention and are included in the spirit and scope of the present disclosure. Furthermore, all conditional terms and embodiments recited herein are intended only for pedagogical purposes to aid the reader in understanding the principles of the invention, and are to be construed as being without limitation to such specifically recited embodiments and conditions.

Moreover, all detailed description herein reciting the principles, aspects, and embodiments of the invention as well as specific embodiments thereof are intended to encompass both structural and functional equivalents thereof. Additionally, it is intended that such equivalents include both currently known equivalents as well as equivalents to be developed in the future, i.e., any elements developed to perform the same function regardless of its structure.

Thus, for example, it will be appreciated by those skilled in the art that the block diagrams presented herein represent the conceptual view of an exemplary circuit that embodies the principles of the invention. Similarly, it will be appreciated that any flow charts, flow diagrams, state transition diagrams, pseudocodes, and the like represent various processes which may be substantially represented in computer readable media and so executed by a computer or processor, whether or not such a computer or processor is explicitly shown.

In addition, explicit use of the terms presented as processors, controls, or concepts similar thereto should not be interpreted by exclusively quoting hardware having an ability of executing software, and should be understood to implicitly include, without limitation, digital signal processor (DSP) hardware, and ROM, RAM and non-volatile memory for storing software. Other known common hardware may also be included.

It should be noted that the terms used herein are merely used to describe a specific embodiment, but not to limit the present disclosure. As used herein, the singular forms are intended to include the plural forms as well, unless the context clearly indicates otherwise. Terms “include” or “have” used herein should be understood that they are intended to indicate the existence of a feature, a number, a step, a constituent element, a component or a combination thereof disclosed in the specification, and it may also be understood that the existence or additional possibility of one or more other features, numbers, steps, constituent elements, components or combinations thereof are not excluded in advance.

The foregoing objects, features and advantages will be more obvious through the following detailed description associated with the accompanying drawings, and accordingly, the technological concept of the present disclosure can be easily implemented by a person having ordinary skill in the art to which the present disclosure pertains. In carrying out the present disclosure, moreover, the detailed description will be omitted when a specific description for publicly known technologies to which the invention pertains is judged to obscure the gist of the present disclosure.

Hereinafter, preferred embodiments according to the present disclosure will be described in detail with reference to the accompanying drawings.

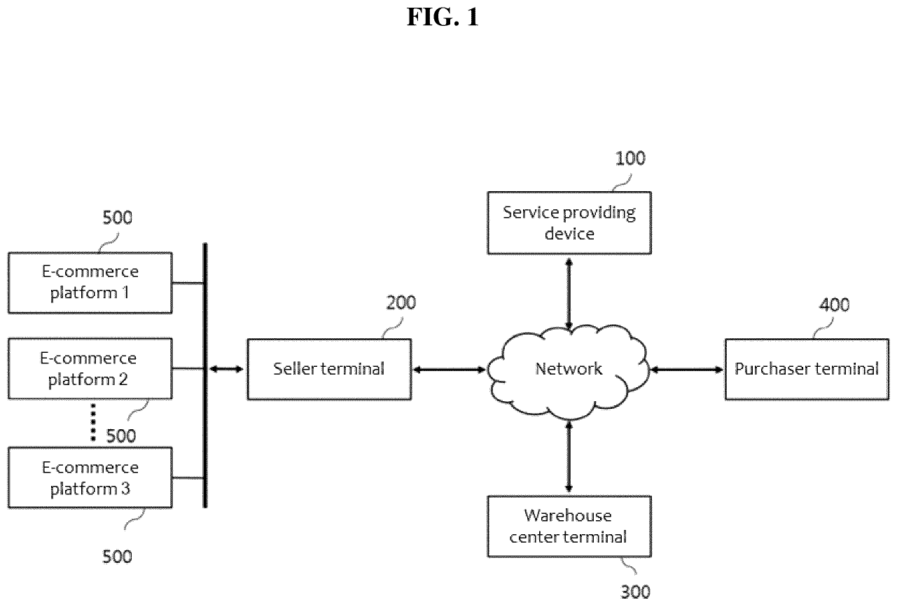

FIG. 1 is a conceptual diagram schematically showing an overall system according to an embodiment of the present disclosure.

Referring to FIG. 1, a system according to an embodiment of the present disclosure may include a service providing device 100, a seller terminal 200, a warehouse center terminal 300, a purchaser terminal 400, and an e-commerce platform 500.

More specifically, the service providing device 100, the seller terminal 200, the warehouse center terminal 300, the purchaser terminal 400, and the e-commerce platform 500 may be connected to a public network in at least one of wired and wireless manners to transmit and receive data thereto and therefrom. The public network, which is a communication network established and managed by the state or key telecommunications service providers, generally includes a telephone network, a data network, a CATV network, a mobile communication network, and the like, and provides connection services so that an unspecified number of people can access other communication networks or the Internet. In the present disclosure, the public network is replaced with a network.

Furthermore, the service providing device 100 may include each communication module for communicating with the seller terminal 200, the warehouse center terminal 300, the purchaser terminal 400, and the e-commerce platform 500 using a protocol corresponding to each communication network.

The service providing device 100 may provide a fulfillment platform in which a seller who is an online seller and a warehouse owner who owns a warehouse center are networked with each other. The service providing device 100 provides all-round logistics services such as warehousing and storage of products, release and shipment of a purchaser's order, return, settlement, and inventory management so as to increase the concentration of product manufacturing or sourcing work and reduce costs on behalf of the seller. Furthermore, the service providing device 100 may connect the seller to the warehouse owner so as to maximize the utilization of the warehouse center through securing goods.

In this way, the service providing device 100 may provide a fulfillment service that can reduce logistics work and related costs for sellers and warehouse owners, thereby processing efficient domestic and international logistics services.

Through this, the service providing device 100 may provide a fulfillment service for products purchased from the e-commerce platform 500 by potential purchasers through the purchaser terminal 400.

In particular, when overseas purchasers purchase products from the domestic e-commerce platform 500 through the purchaser terminal 400, the service providing device 100 may detect the language of the country used in the purchase information input by the purchaser terminal 400 or a specific language such as English, translate or convert the detected language into a preset language, and display them side-by-side.

Here, the service providing device 100 may provide a pre-shipment service of purchased products in order to minimize a logistics processing period required due to physical and administrative characteristics in cross-border type logistics processing performed through cross-border movement. The pre-shipment service may reduce a time period required from warehousing of products for cross-border logistics processing of purchased products to shipping instructions, thereby performing multi-packaging and shipping while at the same time warehousing products as an immediate step. As such, the service providing device 100 may provide a service specialized in cross-border logistics processing based on fulfillment.

In addition, the service providing device 100 may provide a packaging service to protect the value and condition of products and maximize logistics processing efficiency in the process of transportation, storage, and handling of the products so as to be specialized in cross-border logistics processing. In particular, the service providing device 100 may provide a packaging or packing optimization service capable of reducing costs, such as multi-packaging of products for the same consignee and efficient use of packaging resources in addition a basic function of the packaging service to protect the value and condition of products.

Specifically, the service providing device 100 may determine an optimal load order and arrangement for unit packaging or multi-packaging with respect to one or more purchased products ordered by a specific purchaser, and recommend a box size therethrough. In addition, the service providing device 100 may determine a multi-shipping situation through multi-packaging with respect to a purchaser's purchase order and process logistics services.

The service providing device 100 may be connected to the seller terminal 200, the warehouse center terminal 300, the purchaser terminal 400, and the e-commerce platform 500 through a wired/wireless network to provide a cross-border e-commerce service for purchased products. Devices or terminals connected to the network may communicate with each other through a preset network channel.

Here, the network may be implemented in all types of wired/wireless networks such as a Local Area Network (LAN), a Wide Area Network (WAN), a Value Added Network (VAN), a Personal Area Network (PAN), a mobile radio communication network, a satellite communication network, or the like.

The service providing device 100 or the e-commerce platform 500 may be implemented as a server device that performs overall functions and roles as a web server, a database, a web application server, and the like.

In addition, the seller terminal 200, the warehouse center terminal 300, and the purchaser terminal 400 described herein include a personal computer (PC), a laptop computer, a digital broadcasting terminal, a personal digital assistant (PDA), and a portable multimedia player (PMP), and the like may be included therein, but the present disclosure may not be limited thereto, and other various devices capable of user input and information display may be included therein.

Additionally, the seller terminal 200, the warehouse center terminal 300, and the purchaser terminal 400 may not be limited to the device classification and may include a server device that can upgrade and expand data processing, storage, and management functions.

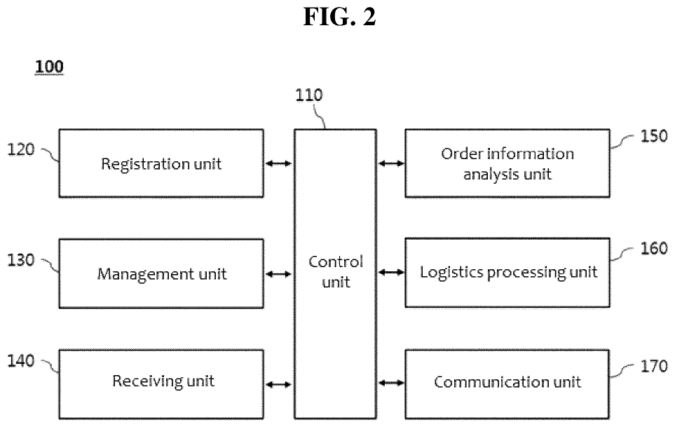

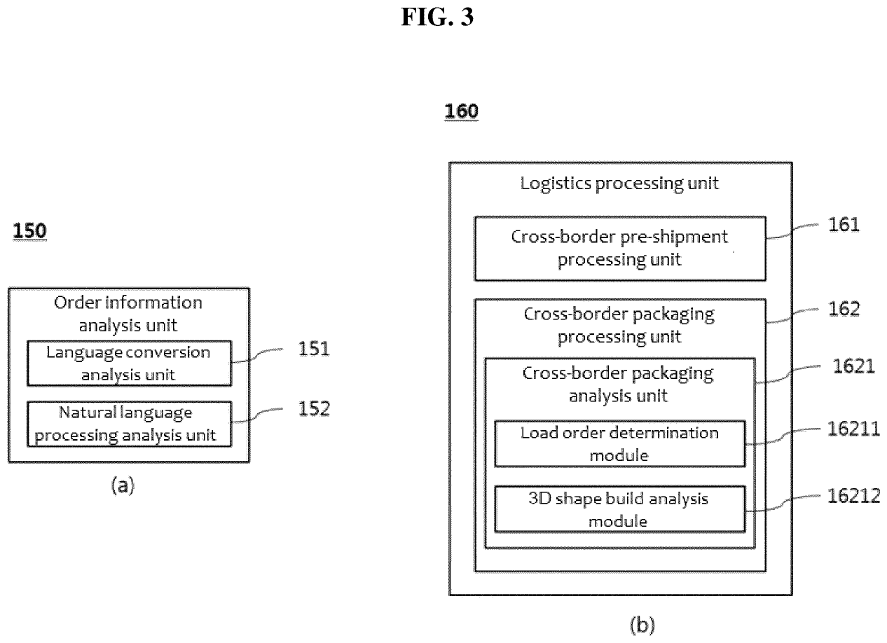

FIG. 2 is a block diagram showing in more detail a fulfillment-based cross-border e-commerce service providing device according to an embodiment of the present disclosure, and FIG. 3 is a block diagram showing in more detail a partial configuration of the fulfillment-based cross-border e-commerce service providing device according to the embodiment of the present disclosure.

Referring to 2 and 3, the service providing device 100 according to an embodiment of the present disclosure may include a control unit 110, a registration unit 120, a management unit 130, a receiving unit 140, an order information analysis unit 150, a logistics processing unit 160, and a communication unit 170.

Referring to (a) of FIG. 3, the order information analysis unit 150 may include a language conversion analysis unit 151 and a natural language processing analysis unit 152.

Referring to (b) of FIG. 3, the logistics processing unit 160 may include a cross-border pre-shipment processing unit 161 and a cross-border packaging processing unit 162. Additionally, the cross-border packaging processing unit 162 may further include a cross-border packaging analysis unit 1621.

The control unit 110 may control an overall operation of each module to provide operation processing according to a service providing method according to an embodiment of the present disclosure, and may include one or more microprocessors for this purpose.

The registration unit 120 may register product information transmitted from the seller terminal 200 or the warehouse center terminal 300. The product information may include detailed information on products manufactured by the seller or secured through sourcing. Specifically, the product information may include a product name, a product image, quantity held, item classification information, capacity or weight, size information, storage method, handling method, volume calculation information of a unit product, and the like.

The volume calculation information of the product may include length information on the width, length, and height of a prototype of the product. In addition, the volume calculation information of the product may be length information on the width, length, and height measured based on a single packaging condition to protect the good and maintain its value.

The management unit 130 may manage logistics data configuration information corresponding to one or more products based on the product information. The management unit 130 may manage logistics data configuration information including updated logistics processing state information such as seller information, warehouse owner information, fulfillment logistics information, and fulfillment operation information and history information based on the product information. In this way, the logistics data configuration information may include information generated from fulfillment services such as warehousing and storage of products, release and shipment, return, settlement, and inventory management.

The logistics data configuration information may be converted into a database so as to be classified and managed in detail. The database may be subclassified into a seller information database, a seller-linked product database, a product inventory database, a product sales history information database, a product-linked warehouse information database, a warehouse information database, an e-commerce platform-lined database, and the like to store and manage information. The databases may be interconnected and combined into a relational database to extract data in combination, and utilized in requested transactions.

Additionally, the management unit 130 may manage load variable information for products included in product information. The management unit 130 may store and manage the load variable information for each unit product. The load variable information may include a capacity, a weight, a volume, volume calculation information, a hardness, a safety level against damage, and the like that can be measured for each unit product. The load variable information may be used to determine a load order for products purchased by a purchaser and an arrangement form of products in a load layer. The load variable information may be classified into a load variable database to be included in the logistics data configuration information.

The load variable information may be quantitatively corresponded to a measured value or an evaluation value so as to be compared with a relative value. For example, weight may be expressed as a mass value that can be measured in units of kg, g, mg, and the like. Furthermore, the safety level against damage may be evaluated as a degree of risk that the quality and value of products provided in the form of food, glass, paper, and the like may be deformed by an external pressure or impact, thereby damaging the quality and value thereof The safety level against damage is a value obtained by evaluating a level of safety against the damage risk, and evaluation information may be numerically matched such as ‘3’ for safe, ‘2’ for normal, and ‘l’ for risky. In addition, the volume, which is a value obtained by measuring a size occupying a space, may be acquired in units such as mm³, cm³, m³, or the like. Additionally, evaluation information may be numerically matched, such as ‘3’ for hard, ‘2’ for normal, and ‘1’ for soft. The evaluation information such as the safety level against damage and the hardness may be evaluated by utilizing information in which a degree of deformation is predictable according to an external pressure, an impact or the like according to product category information, a product provision type, a product manufacturing material, a product item type, and the like in the product information.

The receiving unit 140 may receive purchase information received from the purchaser terminal 400 and transmitted via the seller terminal 200 or the e-commerce platform 500. The purchaser terminal 400 may generate purchase information by inputting or selecting product information to be purchased with respect to products registered in the e-commerce platform 500 by the seller terminal 200. The e-commerce platform 500 may include open markets, social commerce, home shopping, and shopping malls exclusively for sellers. The receiving unit 140 may receive purchase information input by way of the purchaser terminal 400 through the e-commerce platform 500. Furthermore, the receiving unit 140 may receive purchase information input by way of the purchaser terminal 400 through the seller terminal 200. The purchase information is generated based on information input by way of the purchaser terminal 400, and the generated purchase information may include information such as orderer information, selected product names, quantities, prices, shipping information, and other requested items.

The order information analysis unit 150 may perform analysis for cross-border logistics processing based on order data corresponding to a preset fulfillment dataset on the basis of the purchase information and the logistics data configuration information, and acquire fulfillment order information as a result of the analysis. The order information analysis unit 150 may refer to updated logistics data configuration information with respect to one or more products corresponding to the purchase information, and analyze information selected or input by way of the purchaser terminal 400 to match order data to a predetermined form of fulfillment dataset.

The order information analysis unit 150 may pre-set request information items for fulfillment logistics processing as the fulfillment dataset. The order information analysis unit 150 may analyze order data collected from one or more seller terminals 200 or the e-commerce platform 500 to correspond information to the fulfillment dataset.

For example, the fulfillment dataset may include items such as input entities, necessary information, and input data values. The input entities may be classified into purchasers, sellers, warehouse centers, and the like. Required information may include consignee, contact, shipping address, postal code, purchaser, item name, quantity, order number, fulfillment code, warehouse information, courier type, domestic and international shipping classification, box information, subsidiary material information, courier cost information, domestic and international invoice information, carrier information, waybill number, overseas shipping information, and the like. Furthermore, the input data may include an input value corresponding to the necessary information.

Additionally, the order information analysis unit 150 may refer to unique identifiers such as member ID, order request date, delivery address information, and the like, from the purchase information to utilize the fulfillment order information so as to perform multi-packaging or multi-shipment according to the selection information of the purchaser terminal 400.

The order information analysis unit 150 may include a language conversion analysis unit 151.

When the purchase information or logistics data configuration information includes a language whose format is different from a preset designated language, the language conversion analysis unit 151 may convert the language into its corresponding designated language according to a preset language analysis indicator, and allow the converted language information acquired as a result of the conversion to be included in the fulfillment order information. The language analysis indicator may include a criterion for a word to be translated or converted into a designated language with respect to a heterogeneous language other than the designated language. Words or trademarks that can be recognized in foreign languages, such as manufacturer or company names, product names, and personal names, may be excluded from translation or conversion.

The language conversion analysis unit 151 may set a specific local language as a designated language. In this case, the language conversion analysis unit 151 may detect a language having a different format from the designated local language. The language conversion analysis unit 151 may distinguish a heterogeneous language included in the purchase information and translate or convert the distinguished language into a designated local language.

For example, in case where Korean is set as a designated language in the purchase information, when a heterogeneous language other than Korean is detected, the language conversion analysis unit 151 may translate or convert the heterogeneous language into Korean and display them side-by-side. Through this, the language conversion analysis unit 151 may prevent confusion or mistranslation due to heterogeneous languages in domestic logistics processing.

The order information analysis unit 150 may further include a natural language processing analysis unit 152.

The natural language processing analysis unit 152 may classify and process the purchase information and the logistics data configuration information into the order data to input order data matching the fulfillment dataset in which logistics item information required for logistics processing is standardized.

The purchase information may be managed as a corresponding specific value according to an order form, which is a dataset configured for each seller terminal 200 or the e-commerce platform 500.

For example, in the case of a first e-commerce platform, the dataset may include an order information form including matching data in the order of consignee, contact, address, postal code, shipping message, and courier information items. In addition, in the case of a second e-commerce platform, the dataset may include an order information form including matching data in the order of courier information, recipient, postal code, address, contact information, and request items. As such, the order of configuring items may be changed according to the order forms of the first e-commerce platform and the second e-commerce platform, and the names of the items may have different textual phrases such as a ‘consignee’ and a ‘recipient’, a ‘shipping message’ and a ‘request’.

Here, the natural language processing analysis unit 152 may standardize item information required for logistics processing into a fulfillment dataset and extract information matching each item information from an order information form of each e-commerce platform 500 to correspond to each other.

In detail, the natural language processing analysis unit 152 may classify item values included in a specific order form provided as the purchase information and order data corresponding to the item values into information such as text, numbers, and symbols. In addition, the natural language processing analysis unit 152 may analyze the meaning of text information by utilizing natural language processing such as a morpheme analysis. The language conversion analysis unit 151 may acquire integrated fulfillment order information by matching item values and order data collected in each order form to a predetermined fulfillment dataset and reconstructing them by utilizing an analysis technique such as the natural language processing.

The logistics processing unit 160 may process a logistics process corresponding to one or more purchased products based on the fulfillment order information. The logistics processing unit 160 may classify domestic and international logistics processing according to the fulfillment order information. In particular, the logistics processing unit 160 may correspond to a logistics process for cross-border logistics processing, such as international transport, customs clearance, and overseas local delivery, when shipping information included in the fulfillment order information is designated as overseas. The logistics processing unit 160 may apply the logistics process step by step to transmit instruction information for logistics processing to the warehouse center terminal 300.

The logistics processing unit 160 may include a cross-border pre-shipment processing unit 161. When the logistics process is a cross-border quick release process, the cross-border pre-shipment processing unit 161 may transmit pre-shipment instruction information for the purchased products to the warehouse center terminal 300 based on the fulfillment order information.

When purchased products are warehoused from a supplier to a designated warehouse center for cross-border logistics processing, the cross-border pre-shipment processing unit 161 may reduce a time period required to request and process shipment after warehousing.

The pre-shipment processing unit 161 may transmit pre-shipment instruction information to the warehouse center terminal 300 in which products are warehoused according to the fulfillment order information to process preliminary work for shipping such as outer packaging and multi-packaging while at the same time warehousing products.

The logistics processing unit 160 may further include a cross-border packaging processing unit 162.

When the logistics process is a cross-border packaging process, the cross-border packaging processing unit 162 may perform, based on cross-border consignee identifier information extracted from the fulfillment order information, repackaging processing on one or more packaging products corresponding to the same cross-border consignee identifier information. The cross-border packaging processing unit 162 may integrally manage cross-border consignee identifier information in the fulfillment order information. The cross-border consignee identifier information may refer to identifier information such as member ID, shipping address, consignee name, contact information, and the like to be utilized as repackaging information to perform multi-packaging and process multi-shipping.

The cross-border packaging processing unit 162 may include a cross-border packaging analysis unit 1621.

The cross-border packaging analysis unit 1621 may analyze a solid packaging method of the packaging products based on load variable information for products included in the product information, and output shipment packaging information as a result of the analysis.

Furthermore, the cross-border packaging analysis unit 1621 may recommend shipment packaging information through an analysis of the solid shape packaging method of the purchased products. The cross-border packaging analysis unit 1621 may present one or more packaging method models through the solid shape packaging method.

The cross-border packaging analysis unit 1621 may recommend recommended shipment packaging information through criteria for efficiently using packaging materials for an outermost shape of packaging or minimizing a volume value of a hollow formed thereinside, among the packaging method models. The shipment packaging information may include volume information of a packaging container or box forming an outermost shape. The shipment packaging information may include a list of packed purchased products and information such as volume information and quantity of each purchased product.

The cross-border packaging analysis unit 1621 may use product information for each product with respect to one or more purchased products included in the purchase information. In addition, the cross-border packaging analysis unit 1621 may acquire the load variable information corresponding to the purchased product. Through this, the cross-border packaging analysis unit 1621 may acquire objectification information by modeling a solid shape of the purchased product.

The cross-border packaging analysis unit 1621 may analyze a packaging method in which an outermost package volume can be a minimum value when multi-packaging is performed by using the objectification information. The cross-border packaging analysis unit 1621 may determine an optimized multi-packaging method through the analysis of the packaging method and recommend the shipment packaging information.

The cross-border packaging analysis unit 1621 may store product classification information acquired through type classification for each product with respect to one or more products corresponding to the purchase information.

The cross-border packaging analysis unit 1621 may set a predetermined criterion for the type classification for each product. The cross-border packaging analysis unit 1621 may subclassify types based on a product category. For example, the product category may be classified into food, fashion, beauty, kitchen products, cleaning products, furniture, baby products, leisure products, home appliances, and hobby products. The cross-border packaging analysis unit 1621 may classify products based on criteria capable of physically or chemically preventing the deterioration, deformation, damage or the like of the products. To this end, the cross-border packaging analysis unit 1621 may classify products into products requiring refrigeration, products requiring freezing, products requiring handling with care, and the like, and store them as product classification information. The cross-border packaging analysis unit 1621 may manage information that classifies products according to the physical or chemical properties of the products as product classification information, thereby utilizing the product classification information as information for determining a packaging method to maintain the value and quality of the products.

The cross-border packaging analysis unit 1621 may analyze the volume information of packaging subsidiary materials in accordance with the packaging subsidiary materials that maintain the quality and value of products according to the product classification information to allow the volume information of the packaging subsidiary materials to be included in the load variable information. The cross-border packaging analysis unit 1621 may select an ice pack, an air cap, a cushioning material, and the like as the packaging subsidiary materials according to the physical or chemical properties of the purchased products to prevent the deterioration, deformation or damage of the products. The cross-border packaging analysis unit 1621 may calculate an input amount with respect to packaging subsidiary materials corresponding to products, and acquire the volume information of the packaging subsidiary materials for the input amount. Through this, the cross-border packaging analysis unit 1621 may calculate the volume of the packaging subsidiary materials combined with the purchased products to allow the volume information of the packaging subsidiary materials to be included in the load variable information for each product. Furthermore, the cross-border packaging analysis unit 1621 may determine the input of a bulkhead or an additional external packaging subsidiary material for a product that needs to be separated according to the characteristics of the packaging subsidiary material added to the purchased product. For example, when the purchase information includes frozen food and clothes, it is necessary to separate the clothes so as not to be damaged by dry ice or ice packs being added thereto to maintain the quality of the frozen food. At this time, the cross-border packaging analysis unit 1621 may additionally input external packaging auxiliary materials, which may include packaging auxiliary materials for frozen food and ice packs or dry ice to separate therefrom.

The cross-border packaging analysis unit 1621 may acquire one or more primary product packaging volume information corresponding to a packaging method for each product group classified into a specific item group in the purchased products and determined by the corresponding packaging method based on the product classification information and the load variable information. The cross-border packaging analysis unit 1621 may check whether the purchased products are individually packed or not, and calculate primary product packaging volume information in which the products are packed individually or in a bundle. The cross-border packaging analysis unit 1621 may determine whether to add a package having a hexahedral form according to the physical or chemical properties of the individually packed purchased products to calculate the primary product packaging volume information.

The cross-border packaging analysis unit 1621 may determine a load method and secondary product package volume information through the analysis of a load order or a load arrangement form based on the load variable information and the primary product packaging volume information.

The cross-border packaging analysis unit 1621 may include the load order determination module 16211. The load order determination module 16211 may acquire the load order information by reflecting a weighted value (WEIGHT) corresponding to a preset importance indicator with respect to information such as a weight, a hardness, a volume, and a safety level against damage, which are extracted from the load variable information.

The importance indicator may be set among load variable information that must be considered to maintain the quality and value of products. The importance indicator may be set by selecting at least one of a weight, a hardness, a volume, a safety level against damage, and the like.

The load order determination module 16211 may assign a weighted value to the importance indicator. The weighted value may be assigned to one or more values by varying designation values so as to differentiate the importance of load variable information designated as an importance indicator.

When the load order determination module 16211 designates the importance indicator as one load variable information, a load order may be determined according to single load variable information. The load order determination module 16211 may determine a load order by analyzing integer values among purchased products using the single load variable information and position the products into a packaging container.

For the load order, as the order of execution is prioritized, it may be relatively positioned at a bottom of the packaging container. In addition, the load order determination module 16211 may preset whether to prioritize the load order based on an ascending order or a descending order with respect to integer values calculated as load variable information.

According to an embodiment of the present disclosure, the load order determination module 16211 may prioritize importance indicators in the order of a weight, a damage risk, a volume, and a hardness from load variable information such as a weight, a hardness, a volume, and a safety level against damage. Here, the load order determination module 16211 may assign the weight, safety level against damage, volume, and hardness, which are importance indicators, to a default value of ‘l’ and specify weighted values to ‘2.5’, ‘2’, and ‘1.5’ for variables, respectively. Accordingly, the load order determination module 16211 may acquire a calculated value in which the weighted values are reflected as ‘2.5’, ‘2’, ‘1.5’, and ‘l’ for the weight, the damage risk, the volume and the hardness, respectively. Accordingly, the load order determination module 16211 may determine a load order according to a mass value measured or identified for each product with respect to a weight having the highest weighted value. Alternatively, the load order determination module 16211 may determine a load order according to values compared through summation by reflecting the weighted values to the load variable information of each product.

For example, when the load variable information is a weight, the load order may be given priority as the measured or acquired mass increases. As a result, the larger the mass of the product, the more pressure may be applied to the bottom, thereby preventing an increase in the risk of deformation or damage of other products positioned at the bottom. In addition, when the load variable information is a volume, the load order may be given priority as the measured or acquired volume increases. This may allow bulky products to occupy space in a first packaging container, thereby maximize space efficiency. Furthermore, when there is no information on the mass, a load order may be determined according to the prediction that the weight may be relatively heavy as the volume increases.

Here, when extracting at least one of the importance indicators from the load variable information, the load order determination module 16211 may determine a load order using only a specific indicator having the highest priority, and also comparison may be made through the summation of weighted values in all indicators to determine the load order.

For example, the load order determination module 16211 may analyze information in which that the weight of a first purchased product is 1 kg, the safety level against damage is ‘3’ corresponding to ‘safe’, the volume is 8 cm³, and the hardness is ‘l’ corresponding to ‘soft’, and the weight of a second purchased product is 2 kg, the safety level against damage is ‘2’ corresponding to ‘normal’, the volume is 6 cm³, and the hardness is ‘2’ corresponding to ‘normal’. The load order determination module 16211 may determine a weight having the highest weighted value as the priority of the load order. Accordingly, the load order determination module 16211 may acquire load order information for positioning the second product having the weight of 2 kg at the bottom first in the load order.

Additionally, the load order determination module 16211 may sum and compare values calculated by multiplying information measured or acquired from each product, from a weight, a safety level against damage, a volume, and a hardness, which are set as the importance indicators, by weighted values. Specifically, in the case of the first purchased product, values calculated by reflecting weighted values on the importance indicators are ‘2.5’ for the weight, ‘6’ for the safety level against damage, ‘12’ for the volume, and ‘l’ for the hardness, and thus the sum value is ‘21.5’. In the case of the first purchased product, values calculated by reflecting weighted values on the importance indicators are ‘5’ for the weight, ‘4’ for the safety level against damage, ‘9’ for the volume, and ‘2’ for the hardness, and thus the sum value is ‘20’. Through this, the load order determination module 16211 may acquire load order information for positioning the first purchased product at the bottom first in the load order.

The cross-border packaging analysis unit 1621 may further include a 3D shape build analysis module 16212.

The 3D shape build analysis module 16212 may perform solid modeling on the shape of the packaging product, and determine the load arrangement form according to a preset load algorithm using solid shape information acquired through the solid modeling and the load order information.

Furthermore, the 3D shape build analysis module 16212 may perform solid modeling on the shape of a primary packaging product group based on the primary product packaging volume information. The 3D shape build analysis module 16212 may determine a load arrangement form according to a preset load algorithm using solid shape information acquired through the solid modeling and the load order information.

The load algorithm may perform fitting so as to be filled in a hexahedral shape using the solid shape information. The load algorithm may generate one or more hexahedral models that are finally filled in according to a selective arrangement form of the fitting.

The 3D shape build analysis module 16212 may select a hexahedral model that is calculated as a value that minimizes a volume value of a hollow formed thereinside among the hexahedral models generated by using the load algorithm, and determine it as outermost product packaging volume information or secondary product packaging volume information.

The 3D shape build analysis module 16212 may provide a build interface that visually displays the load form. The build interface provides a 360° rotational view to check a load form of the solid shape information from various viewpoints.

In addition, the 3D shape build analysis module 16212 may allow a manager to directly control an arrangement form of products or a load layer structure of products using one or more solid shape information. To this end, the 3D shape build analysis module 16212 may provide a drag-and-drop function on the solid shape information within a specific space.

The 3D shape build analysis module 16212 may utilize a Maxrects (Maximal Rectangle) algorithm or the like as the load algorithm. When a first rectangular object is initially placed in a two-dimensional space of a predetermined size, with respect to a remaining region except for a region occupied by the first rectangular object, the Maxrects (Maximal Rectangle) algorithm may extend a region in an overlapping portion to the remaining region to avoid fragmentation so as to classify the extended region as an additional load region. The Maxrects (Maximal Rectangle) algorithm may arrange a second rectangle object, a third rectangle object, and the like that can be included in the additional load region to utilize the calculated region. The 3D shape build analysis module 16212 may utilize the Maxrects (maximal rectangle) algorithm by using horizontal, vertical, and height information, width, and volume that may be calculated from the solid shape information.

Here, the 3D shape build analysis module 16212 may perform fitting on one or more solid shape information according to three-dimensional coordinates using the load algorithm to determine a load form. In addition, the 3D shape build analysis module 16212 may determine lengths for a width, a depth, and a height extended as the solid shapes are selectively fitted as a volume value of the outermost packaging hexahedron.

The 3D shape build analysis module 16212 may provide logic for determining a load method. The 3D shape build analysis module 16212 may generate a hexahedron having a size including the volume of purchased products having various shapes. The hexahedron may be generated in a form capable of minimizing a hollow formed therein. The 3D shape build analysis module 16212 may position a first hexahedron having the highest priority in the load order so as to be in contact with the origin of the three-dimensional coordinates x, y, and z axes. The 3D shape build analysis module 16212 may divide a space using three edges of the hexahedron that are not in contact with the x, y, and z axes. In this case, the 3D shape build analysis module 16212 may utilize a Maxrects (Maximal Rectangle) algorithm. Thereafter, the 3D shape build analysis module 16212 may load a second hexahedron so as to be in contact with the first hexahedron, and then determine whether the second hexahedron can be included in the divided space, and position the second hexahedron in an available space. Furthermore, after the second hexahedron is positioned therein, the 3D shape build analysis module 16212 re-divides the divided space using each corner of the second hexahedron. At this time, the 3D shape build analysis module 16212 may remove an invalid space. The invalid space may be divided into a region included in another space or a region having a negative height or width value. Through this, the 3D shape build analysis module 16212 may remove an invalid space and analyze whether the hexahedrons of all products, which are subject to multi-packaging, may be included in the re-divided space. The 3D shape build analysis module 16212 may recognize an object in which hexahedrons of products overlap each other as one object, and determine dimensions of a packaging hexahedron that fits a length of the largest side.

According to an embodiment of the present disclosure, the 3D shape build analysis module 16212 may use rectangular objects having x, y, w (width), and h (height) as attributes thereof to remove an invalid space when dividing an area in a specific region. are available. Specifically, the 3D shape build analysis module 16212 may define top, bottom, left, and right spaces according to the first rectangular object that is loaded first to become a reference position, wherein “r” refers to a rectangular object, and “s” is defined as a space overlapping a rectangular object. The 3D shape build analysis module 16212 may allow rectangular objects in the top, bottom, left, and right spaces to sequentially match rt, rb, rl, and rr, respectively. Through this, the 3D shape build analysis module 16212 may acquire information rt, rb, rl, and rr as follows. For example, rt, rb, rl and rr may be calculated by using rt={x:s.x, y:s.y, w:s.w, h:r.y-s.y}, rb={x:s.x, y:r.y+r.h, w:s.w, h:s.y+s.h−(r.y+r.h)}, rl={x:s.x, y:s.y, w:r.x-s.x, h:s.h}, and rr={x:r.x+r.w, y:s.y, w:s.x+s.w−(r.x+r.w)}, respectively.

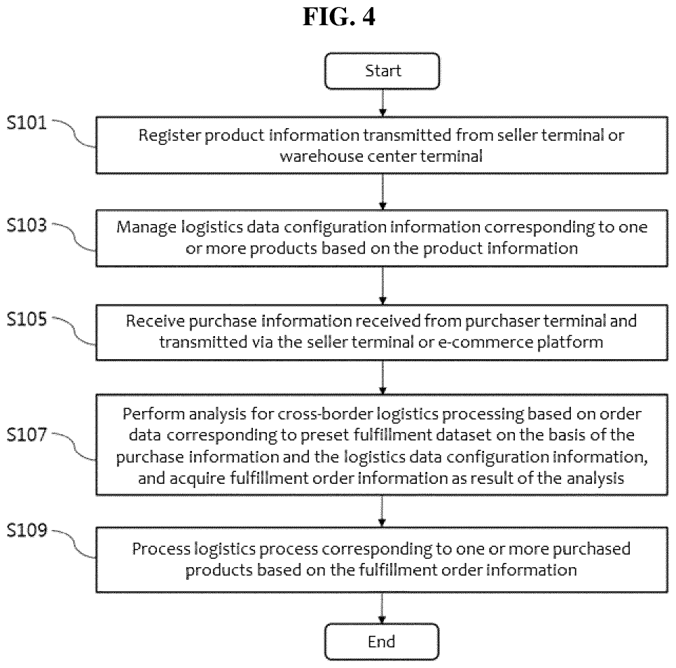

FIG. 4 is a flowchart for explaining in more detail an operation of the fulfillment-based cross-border e-commerce service providing device according to the embodiment of the present disclosure.

Referring to FIG. 4, in an operating method of a fulfillment-based cross-border e-commerce service providing device according to an embodiment of the present disclosure, a registration step S101 may register product information transmitted from the seller terminal 200 or the warehouse center terminal 300.

The product information may include detailed information on products manufactured by the seller or secured through sourcing. Specifically, the product information may include a product name, a product image, quantity held, item classification information, capacity or weight, size information, storage method, handling method, volume calculation information of a unit product, and the like.

The management step S103 may manage logistics data configuration information corresponding to one or more products based on the product information. The management step S103 may manage logistics data configuration information including updated logistics processing state information such as seller information, warehouse owner information, fulfillment logistics information, and fulfillment operation information and history information based on the product information. Specifically, the logistics data configuration information may include information generated from fulfillment services such as warehousing and storage of products, release and shipment, return, settlement, and inventory management.

The receiving step S105 may receive purchase information received from the purchaser terminal 400 and transmitted via the seller terminal 200 or the e-commerce platform 500. The purchaser terminal 400 may generate the purchase information by inputting or selecting product information to be purchased with respect to products registered in the e-commerce platform 500 by the seller terminal 200. The e-commerce platform 500 may include open markets, social commerce, home shopping, and shopping malls exclusively for sellers. The receiving unit 140 may receive purchase information input by way of the purchaser terminal 400 through the e-commerce platform 500. Furthermore, the receiving unit 140 may receive purchase information input by way of the purchaser terminal 400 through the seller terminal 200. The purchase information is generated based on information input by way of the purchaser terminal 400, and the generated purchase information may include information such as orderer information, selected product names, quantities, prices, shipping information, and other requested items.

The analysis step S107 may perform analysis for cross-border logistics processing based on order data corresponding to a preset fulfillment dataset on the basis of the purchase information and the logistics data configuration information, and acquire fulfillment order information as a result of the analysis.

The analysis step S107 may further include a language conversion analysis step (not shown).

When the purchase information or logistics data configuration information includes a language whose format is different from a preset designated language, the language conversion analysis step may convert the language into its corresponding designated language according to a preset language analysis indicator, and allow the converted language information acquired as a result of the conversion to be included in the fulfillment order information.

The analysis step S107 may further include a natural language processing analysis step (not shown).

The natural language processing analysis step may classify and process the purchase information and the logistics data configuration information into the order data to input specific matching information to the fulfillment dataset in which logistics item information required for logistics processing is standardized.

The processing step S109 may process a logistics process corresponding to one or more purchased products based on the fulfillment order information.

The processing step S107 may include a cross-border pre-shipment processing step (not shown).

When the logistics process is a cross-border quick release process, the cross-border pre-shipment processing step may transmit pre-shipment instruction information for the purchased products to the warehouse center terminal 300.

The processing step S107 may further include a cross-border packaging processing step (not shown).

When the logistics process is a cross-border packaging process, the cross-border packaging processing step may perform, based on cross-border consignee identifier information extracted from the fulfillment order information, repackaging processing on one or more packaging products corresponding to the same cross-border consignee identifier information.

The cross-border packaging processing step may integrally manage cross-border consignee identifier information in the fulfillment order information. The cross-border consignee identifier information may refer to identifier information such as member ID, shipping address, consignee name, contact information, and the like to be utilized as repackaging information to perform multi-packaging and process multi-shipping.

The cross-border packaging processing step may include a cross-border packaging step (not shown).

The cross-border packaging step may analyze a solid packaging method of the packaging products based on load variable information for products included in the product information, and output shipment packaging information as a result of the analysis.

The load variable information may include a capacity, a weight, volume calculation information, a hardness, a safety level against damage, and the like that can be measured for each unit product. The load variable information may be used to determine a load order for products purchased by a purchaser and an arrangement form of products in a load layer.

The cross-border packaging step may further include a load order determination step (not shown). The load order determination step may acquire the load order information by reflecting a weighted value (WEIGHT) corresponding to a preset importance indicator to information including at least one of a weight, a hardness, a volume, and a safety level against damage, which are extracted from the load variable information.

The cross-border packaging step may further include a 3D shape build analysis step (not shown). The 3D shape build analysis step may perform solid modeling on the shape of the packaging product, and determine the load arrangement form according to a preset load algorithm using solid shape information acquired through the solid modeling and the load order information. The load algorithm may perform fitting so as to be filled in a hexahedral form using the solid shape information, generate one or more hexahedral models according to a selective arrangement form of the fitting, and determine a hexahedral model that is calculated as a value that minimizes a volume value of a hollow formed therein among the hexahedral models as outermost product packaging volume information.

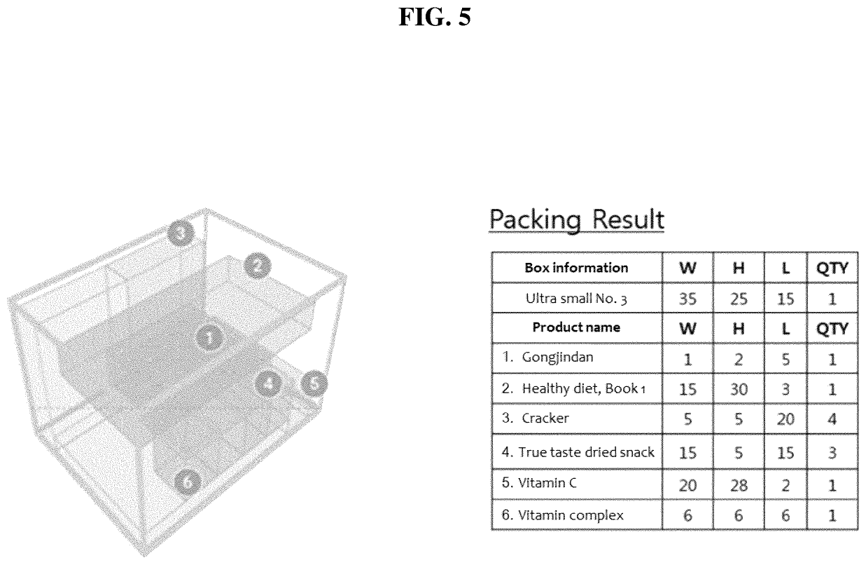

FIG. 5 is an exemplary diagram for explaining shipment packaging information provided through the fulfillment-based cross-border e-commerce service providing device according to the embodiment of the present disclosure.

Referring to FIG. 5, the service providing device 100 may visually provide a load arrangement form in the outermost hexahedron packaging box according to a solid shape for one or more purchased products ordered by the purchaser terminal 400. Furthermore, the service providing device 100 may provide detailed multi-packaging information on purchased products. The service providing device 100 may provide box information and information according to a product list as ‘packing result’ information. The box information may include box volume information. In addition, the product list may include single packaging volume information and quantity information corresponding to a list of products purchased by the purchaser.

Meanwhile, the method according to various embodiments of the present disclosure described above may be implemented in the form of installation data to be executed in a terminal device and provided to each server or device while being stored in various non-transitory computer-readable media.

The non-transitory computer-readable medium refers to a medium which stores data semi-permanently and is readable by a device rather than a medium storing data for a short time such as a register, a cache, a memory, and the like. Specifically, the various applications or programs described above may be stored and provided in a non-transitory computer-readable medium such as a CD, a DVD, a hard disk, a Blu-ray disk, a USB, a memory card, or a ROM.

While the invention has been shown and described with respect to various embodiments of the present disclosure, it will be of course understood by those skilled in the art that various modifications may be made without departing from the gist of the invention as defined in the following claims, and it is to be noted that those modifications should not be understood individually from the technical concept and prospect of the present disclosure.

1. A service providing device comprising:
a registration unit that registers product information transmitted from a seller terminal or a warehouse center terminal;
a management unit that manages logistics data configuration information corresponding to one or more products based on the product information;
a receiving unit that receives purchase information received from a purchaser terminal and transmitted via an e-commerce platform or the seller terminal;
an order information analysis unit that performs analysis for cross-border logistics processing based on order data corresponding to a preset fulfillment dataset on the basis of the purchase information and the logistics data configuration information, and acquires fulfillment order information as a result of the analysis; and
a logistics processing unit that processes a logistics process corresponding to one or more purchased products based on the fulfillment order information.

2. The service providing device of claim 1, wherein when the purchase information or logistics data configuration information comprises a language whose format is different from a preset designated language, the order information analysis unit comprises a language conversion analysis unit that converts the language into its corresponding designated language according to a preset language analysis indicator, and allows the converted language information acquired as a result of the conversion to be included in the fulfillment order information.

3. The service providing device of claim 2, wherein the order information analysis unit further comprises a natural language processing analysis unit that classifies and process the purchase information and the logistics data configuration information into the order data to input specific matching information to the fulfillment dataset in which logistics item information required for logistics processing is standardized.

4. The service providing device of claim 1, wherein the logistics processing unit comprises a cross-border pre-shipment processing unit that transmits pre-shipment instruction information for the purchased products to the warehouse center terminal when the logistics process is a cross-border quick release process.

5. The service providing device of claim 4, wherein the logistics processing unit further comprises a cross-border packaging processing unit that performs repackaging processing on one or more packaging products corresponding to the same cross-border consignee identifier information based on cross-border consignee identifier information extracted from the fulfillment order information when the logistics process is a cross-border packaging process.

6. The service providing device of claim 5, wherein the cross-border packaging processing unit comprises a cross-border packaging analysis unit that analyzes a solid shape packaging method of the packaging products based on load variable information for products included in the product information, and outputs shipment packaging information as a result of the analysis.

7. The service providing device of claim 6, wherein the cross-border packaging analysis unit comprises a load order determination module that acquires the load order information through reflecting a weighted value (WEIGHT) corresponding to a preset importance indicator with respect to information including at least one of a weight, a hardness, a volume, and a safety level against damage, which are extracted from the load variable information.

8. The service providing device of claim 7, wherein the cross-border packaging analysis unit further comprises a 3D shape build analysis module that performs solid modeling on the shape of the packaging product, and determines a load arrangement form according to a preset load algorithm using solid shape information acquired through the solid modeling and the load order information, and
wherein the load algorithm performs fitting so as to be filled in a hexahedral form using the solid shape information, generates one or more hexahedral models according to a selective arrangement form of the fitting, and determines a hexahedral model that is calculated as a value that minimizes a volume value of a hollow formed therein among the hexahedral models as outermost product packaging volume information.

9. A method of operating a service providing device, the method comprising:
a registration step of registering product information transmitted from a seller terminal or a warehouse center terminal;
a management step of managing logistics data configuration information corresponding to one or more products based on the product information;
a receiving step of receiving purchase information received from a purchaser terminal and transmitted via an e-commerce platform or the seller terminal;
an analysis step of performing analysis for cross-border logistics processing based on order data corresponding to a preset fulfillment dataset on the basis of the purchase information and the logistics data configuration information, and acquiring fulfillment order information as a result of the analysis; and
a processing step of processing a logistics process corresponding to one or more purchased products based on the fulfillment order information.

10. The method of claim 9, wherein when the purchase information or logistics data configuration information comprises a language whose format is different from a preset designated language, the analysis step comprises a language conversion analysis step of converting the language into its corresponding designated language according to a preset language analysis indicator, and allowing the converted language information acquired as a result of the conversion to be included in the fulfillment order information.

11. The method of claim 10, wherein the analysis step further comprises a natural language processing analysis step of classifying and processing the purchase information and the logistics data configuration information into the order data to input specific matching information to the fulfillment dataset in which logistics item information required for logistics processing is standardized.

12. The method of claim 9, wherein the processing step comprises a cross-border pre-shipment processing step of transmitting pre-shipment instruction information for the purchased products to the warehouse center terminal when the logistics process is a cross-border quick release process.

13. The method of claim 12, wherein the processing step further comprises a cross-border packaging processing step of, based on cross-border consignee identifier information extracted from the fulfillment order information, performing repackaging processing on one or more packaging products corresponding to the same cross-border consignee identifier information when the logistics process is a cross-border packaging process.

14. The method of claim 13, wherein the cross-border packaging processing step comprises a cross-border packaging step that analyzes a solid packaging method of the packaging products based on load variable information for products included in the product information, and outputs shipment packaging information as a result of the analysis.

15. The method of claim 14, wherein the cross-border packaging step comprises a load order determination step of acquiring the load order information through reflecting a weighted value (WEIGHT) corresponding to a preset importance indicator with respect to information including at least one of a weight, a hardness, a volume, and a safety level against damage, which are extracted from the load variable information.

16. The method of claim 15, wherein the cross-border packaging step further comprises a 3D shape build analysis step of performing solid modeling on the shape of the packaging product, and determining a load arrangement form according to a preset load algorithm using solid shape information acquired through the solid modeling and the load order information, and
wherein the load algorithm performs fitting so as to be filled in a hexahedral form using the solid shape information, generates one or more hexahedral models according to a selective arrangement form of the fitting, and determines a hexahedral model that is calculated as a value that minimizes a volume value of a hollow formed therein among the hexahedral models as outermost product packaging volume information.

17. A computer-readable, non-volatile program for executing a logistics automation service process based on direct purchase and reverse direct purchase, the program comprising:
a process of performing analysis for cross-border logistics processing based on order data corresponding to a preset fulfillment dataset on the basis of product information, purchase information, and logistics data configuration information;
a process of acquiring fulfillment order information as a result of the analysis and processing a logistics process corresponding to one or more purchased products; and
a process of, when the purchase information or logistics data configuration information comprises a language whose format is different from a preset designated language, converting the language into its corresponding designated language according to a preset language analysis indicator through natural language analysis processing, and allowing the converted language information acquired as a result of the conversion to be included in the fulfillment order information.

18. The program of claim 17, wherein a process of transmitting pre-shipment instruction information for the purchased products to a warehouse center terminal is performed when the logistics process is a cross-border quick release process, and a process of, based on cross-border consignee identifier information extracted from the fulfillment order information, performing repackaging processing on one or more packaging products corresponding to the same cross-border consignee identifier information when the logistics process is a cross-border packaging process.
